(19) United States
(12) Patent Application Publication
(10) Pub. No.: US 2003/0031006 A1
(43) Pub. Date: Feb. 13, 2003

(54) Surface illuminating device

(76) Inventor: Kuo-Jui Huang, Chia-Yi Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/925,379

(22) Filed: Aug. 10, 2001

(51) Int. Cl. G01D 11/28

(52) U.S. Cl. 362/26; 362/31

(57) ABSTRACT

A surface illuminating device comprises a light source set and a light guiding plate. The light source set has light guiding rod being installed with a respective point source at two ends. The reflective surface of the light guiding rod has plurality of reflective grooves defining a first surface corresponding to the first point source and a second surface corresponding to the second point source. The angles between the first and second surfaces and the reflective surface are from 40 degrees to 86 degrees. The orientations and the spacings of the reflective grooves are symmetric. The top surface of the light guiding plate has a plurality of light guiding grooves having a third surface and a fourth surface; the angles between the third surface and fourth surface and top surface are from 47 degrees to 86 degrees. Therefore, the light is uniformly guided to a liquid crystal panel so as to increase the illumination and uniformity.

### FIELD OF THE INVENTION

The present invention relates to a surface illuminating device having a light guiding rod and a light guiding plate. The reflective grooves of the light guiding rod are spaced arranged at the right and left sides of a middle point of the light guiding rod. The reflective grooves of the light guiding rod are arranged at a preset angle so that light can be concentrated uniformly to be guided to a liquid crystal panel.

### BACKGROUND OF THE INVENTION

Referring to FIG. 5, a prior surface illuminating device is illustrated. The surface illuminating device has a light guiding rod 8. One end of the light guiding rod 8 has a point light source 81. The light guiding rod 8 has a reflective surface 82 and a light output surface 83. The reflective surface 82 is arranged with a plurality of reflective portions 821 alternatively. Each reflective portion 821 has a saw teeth shape. Thereby, light emitted from the point light source 81 is diffused and reflected and then is transferred to a light guiding plate 84. Then the light is reflected from the light guiding plate 84 to a liquid crystal panel (not shown).

Since the reflective portions 821 diffuses and reflects light to the light guiding plate 84, the light is uniformly distributed. But light can not be concentrated so that a large part of the light is dispersed to be out of the light guiding plate 84. Therefore, the light reflected to the light guiding plate 84 is weak so that the illumination of the liquid crystal panel is insufficient.

With reference to FIG. 6, another surface illuminating device of the prior art is illustrated. The surface illuminating device has a light guiding rod 9. One end of the light guiding rod 9 has a point light source 91. The light guiding rod 9 has a reflective surface 92. The reflective surface 92 is arranged with a plurality of V shape reflective groove 94. Thereby, by the reflected tilt surface 941 of each reflective groove 94, the light from the point light source 91 is reflected out from the light output surface 93 to a light guiding plate 95. Then the light is reflected from the light guiding plate 95 to a liquid crystal panel (not shown).

Since the reflective grooves 94 have a V shape and are arranged regularly, the light from the point light source 91 is uniformly reflected to the light guiding plate 94. However, since each reflective groove has the same orientation, i.e., each reflecting tilt surface 941 has the same angle, while the distances of each reflective groove 94 to the point light source 91 are different, light has different incident angles with respect to each reflective tilt surface 941. That is, each reflective tilt surface 941 has a different reflective angle. Therefore, the light reflective from the tilt surface 941 to the light guiding plate 95 can not be concentrated. Therefore, as comparing with the former surface illuminating device having diffusion and reflecting function, this design has a stronger illumination, but the extent of the improvement is only a little. Therefore, a novel surface illuminating device is desired for further improving the prior designs.

### SUMMARY OF THE INVENTION

Accordingly, the primary object of the present invention is to provide a surface illuminating device comprising a light guiding rod and a light guiding plate. The light source set has light guiding rod. Two ends of the light guiding rod are installed with respective point sources, respectively. The reflective surface of the light guiding rod has plurality of reflective grooves. Each reflective groove defines a first surface corresponding to the first point source and a second surface corresponding to the second point source. The angles between the first and second surfaces and the reflective surface are from 40 degrees to 86 degrees. Orientations and the spacings of the reflective grooves are symmetric in left and right sides along a middle line formed by the light guiding rod. The top surface of the light guiding plate has a plurality of light guiding grooves having a third surface and a fourth surface; the angles between the third surface and the top surface and the fourth surface and top surface are from 47 degrees to 86 degrees. Therefore, the light is uniformly guided to a liquid crystal panel so as to increase the illumination and uniformity.

The various objects and advantages of the present invention will be more readily understood from the following detailed description when read in conjunction with the appended drawing.

### BRIEF DESCRIPTION OF THE DRAWINGS

FIG. 1 is a structural schematic view of the present invention.

FIG. 2 is a plane schematic view of the present invention.

FIG. 3 is a schematic view showing the light reflection of the reflective groove of the light guiding rod according to the present invention.

FIG. 4 is a schematic view showing the light reflection of the light guiding groove of the light guiding rod according to the present invention.

FIG. 5 shows a prior surface illuminating device.

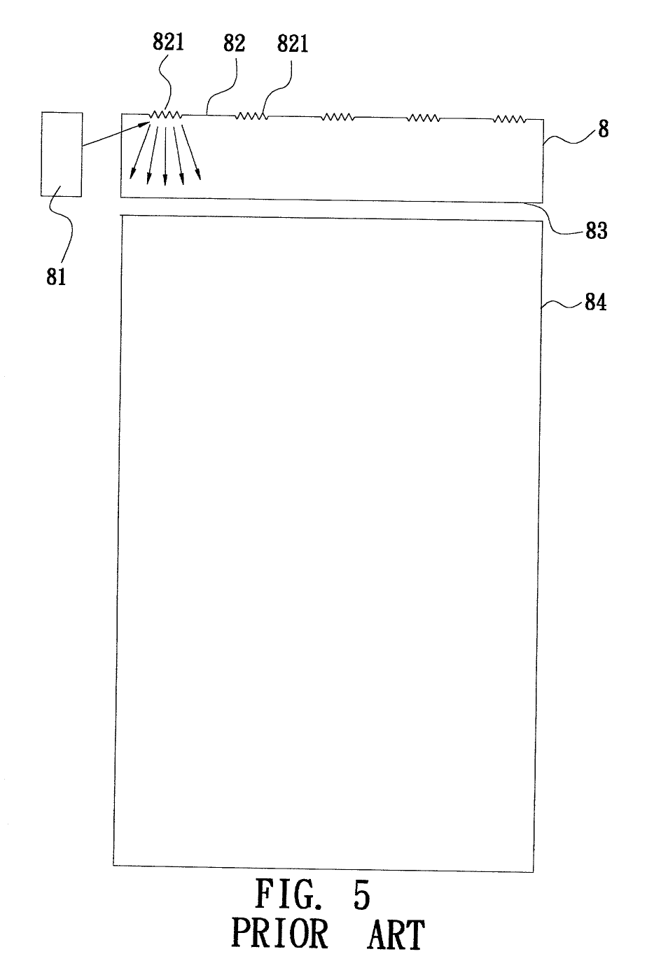

FIG. 6 shows another prior surface illuminating device.

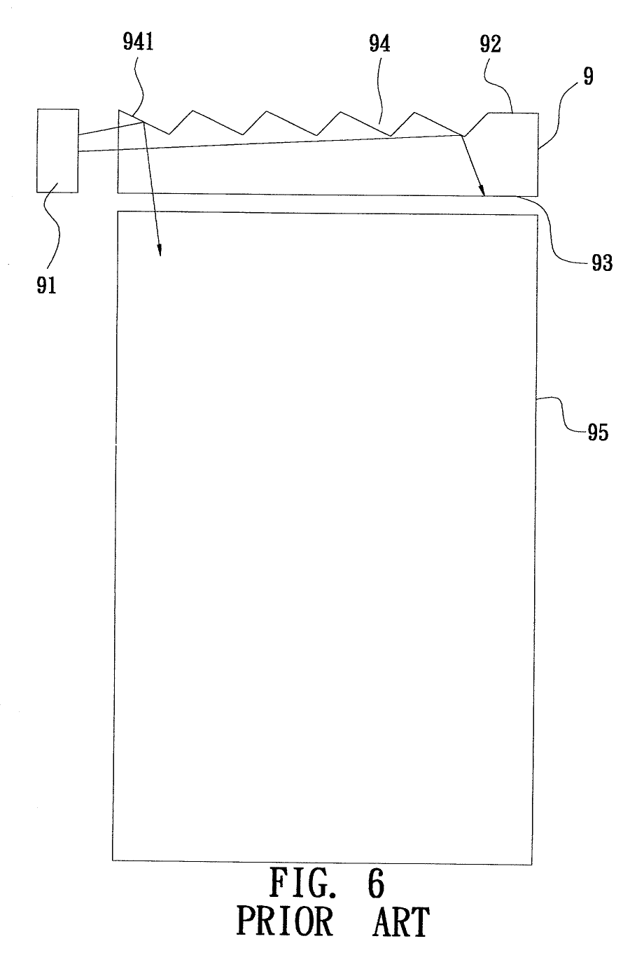

### DETAILED DESCRIPTION OF THE PREFERRED EMBODIMENTS

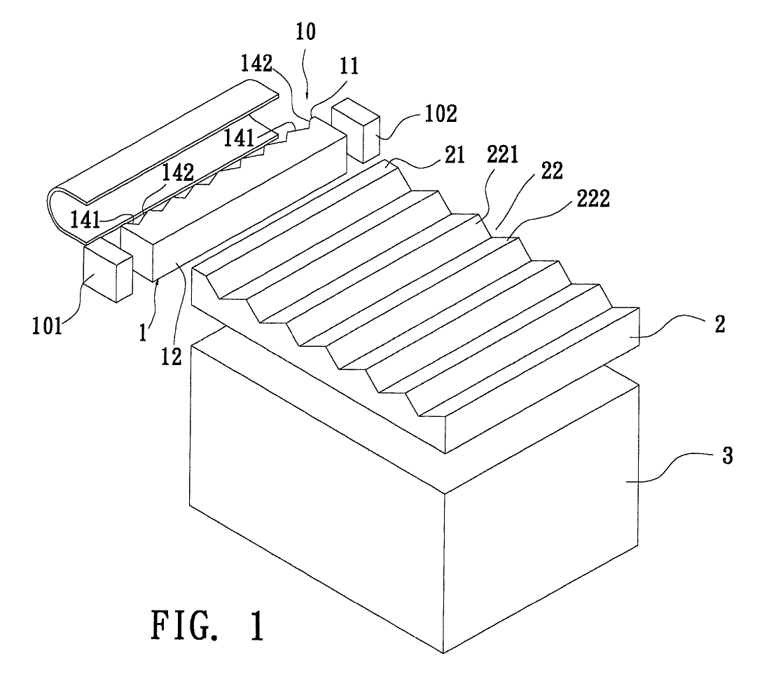

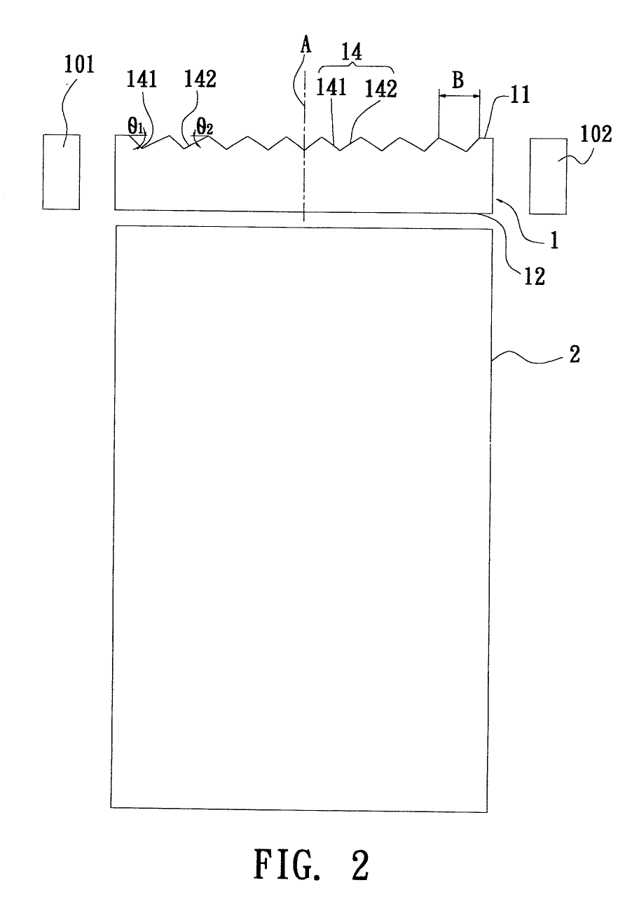

Referring to FIGS. 1 to 4, the surface illuminating device of the present invention is illustrated. The present invention includes the following components.

A light source set 10 has a light guiding rod 1. Two ends of the light guiding rod 1 are installed with a first point source 101 and a second point source 102, respectively. Two sides of the light guiding rod 1 have a reflective surface 11 and a light output surface 12. The light guiding rod 1 has a cambered reflective cover 13 at the side of and coaxially with the reflective surface 11. The reflective surface 11 has a plurality of reflective groove 14 with an approximately V shape. Each reflective groove 14 defines a first surface 141 corresponding to the first point source 101 and a second surface 142 corresponding to the second point source 102. The angles θ1 and θ2 between the first surface and the reflective surface 11 and between the second surface and the reflective surface 11 are from 40 degrees to 86 degrees. Orientations and the spacings of the reflective grooves 14 are symmetric in left and right sides along a middle line A formed by the light guiding rod 1. The spacing B of two reflective grooves 14 is from 0.05 mm to 0.3 mm.

A light guiding plate 2 is adjacent to the light output surface 12 of the light guiding rod 1. A top surface 21 of the light guiding plate 2 has a plurality of light guiding grooves 22. Each light guiding groove 22 has an approximate V shape and has a third surface 221 and a fourth surface 222. The angles between the third surface 221 and the top surface 21 and the fourth surface 222 and top surface 21 are from 47 degrees to 86 degrees. The spacing C of two light guiding grooves 22 are between 0.2 mm and 0.3 mm.

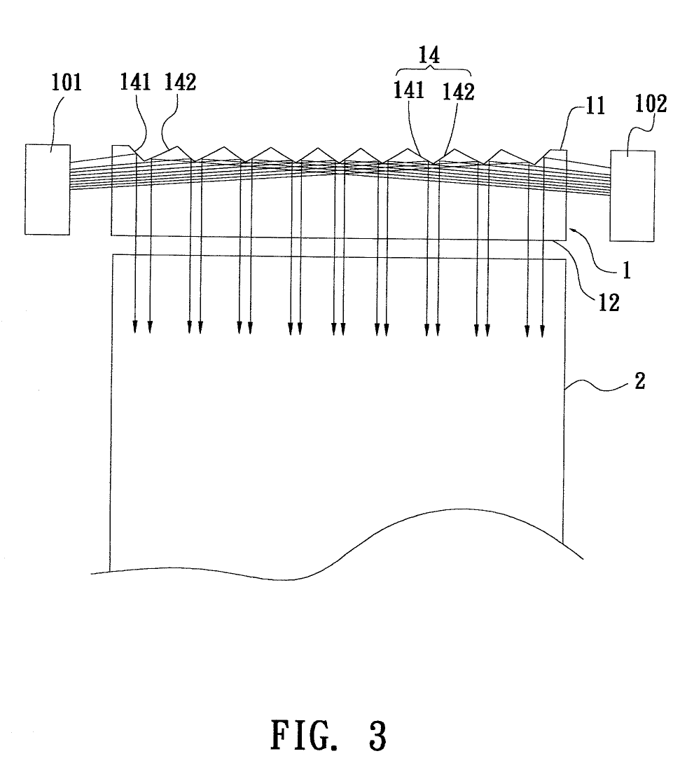

Referring to FIG. 3, each reflective groove 14 of the light guiding rod 1 defines a first surface 141 corresponding to the first point source 101 and a second surface 142 corresponding to the second point source 102. The angles θ1 and θ2 between the first surface and the reflective surface 11 and between the second surface and the reflective surface 11, respectively, are from 40 degrees to 86 degrees. The angles θ1 and θ2 between the first surface and the reflective surface 11 and between the second surface and the reflective surface 11, respectively are larger when near the first point source 101 and the second point source 102. The orientations and the spacings of the angles θ1 and θ2 between the first surface and the reflective surface 11 and between the second surface and the reflective surface 11 are symmetric in left and right sides along a middle line A formed by the light guiding rod 1. Therefore, the light emitted from the first and second point light sources 101, and 102 are reflected by the first and second surfaces 141, 142 of the reflective groove 14 and then is reflected by the light output surface 12 to the light guiding plate 2 with a reflecting angle of approximate 0 degree. Since light emitted from the first and second point light sources 101, and 102 are reflected by the first and second surfaces 141, 142 of the reflective groove 14 and then is reflected by the light output surface 12 to the light guiding plate 2 uniformly and concentratedly with a reflecting angle of approximate 0 degree. Only a little light will radiate out of the light guiding plate 2 so that the light guiding rod 1 may transfer light efficiently.

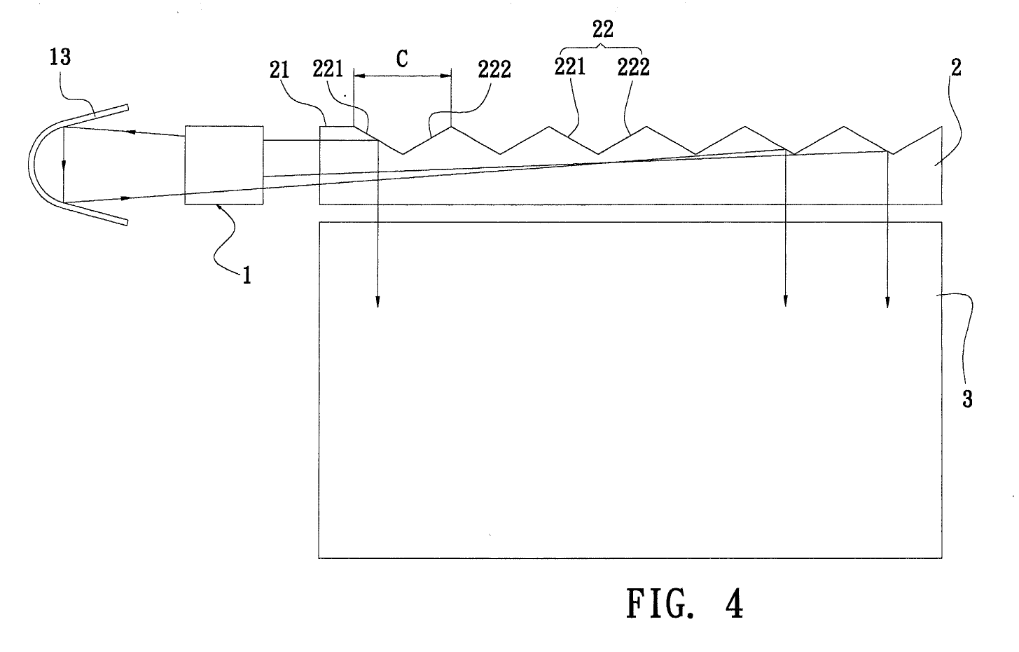

Referring to FIG. 4, since the plurality of light guiding grooves 22 on the top surface 21 of the light guiding plate 2 are spaced-distributed. The angles between the third and fourth surfaces 221, 222 and the top surfaces 21 are between 47 degrees and 86 degrees. Therefore, the light reflected from the light guiding rod 1 to the light guiding plate 2 may be reflected by the third and fourth surfaces 221 and 222 of the light guiding groove 22 to be uniformly guided to a liquid crystal panel so as to increase the illumination and uniformity.

In summary, in the present invention, since the reflective grooves 14 of the light guiding rod 1 are spaced-distributed symmetrically in left and right sides. The first and second 101, 102 of the reflective groove 14 with respect to the two ends of the light guiding rod 1 have a first surface, 141 and a second surface 142. Since the angles between the first surface and the reflective surface 11 and between the second surface and the reflective surface 11 are from 40 degrees to 86 degrees, the light from the first point source 101 and the second point source 102 are uniformly and concentratedly reflected to the light guiding plate 2. The angles between the third and fourth surfaces 221, 222 and the top surfaces 21 are between 47 degrees and 86 degrees. Therefore, the light is uniformly guided to a liquid crystal panel so as to increase the illumination and uniformity.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A surface illuminating device comprising:
a light source set having a light guiding rod; two ends of the light guiding rod being installed with a first point source and a second point source, respectively; two sides of the light guiding rod having a reflective surface and a light output surface; the light guiding rod having a cambered reflective cover at the side of and coaxially with the reflective surface; the reflective surface having a plurality of reflective grooves with an approximately V shape; each reflective groove defining a first surface corresponding to the first point source and a second surface corresponding to the second point source; the angles between the first surface and the reflective surface and between the second surface and the reflective surface being from 40 degrees to 86 degrees; each orientations and the spacings of the reflective grooves being symmetric in left and right sides along a middle line formed by the light guiding rod;
a light guiding plate being adjacent to the light output surface of the light guiding rod; a top surface of the light guiding plate having a plurality of light guiding grooves; each light guiding groove having an approximate V shape and having a third surface and a fourth surface; the angles between the third surface and the top surface and the fourth surface and top surface are from 47 degrees to 86 degrees.

2. The surface illuminating device as claimed in claim 1, wherein a spacing of two reflective grooves on the reflective surface of the light guiding rod is from 0.05 mm to 0.3 mm.

3. The surface illuminating device as claimed in claim 1, wherein a spacing of two light guiding grooves of the light guiding plate is between 0.2 mm and 0.3 mm.
